(19) United States
(12) Patent Application Publication
(10) Pub. No.: US 2019/0387883 A1
(43) Pub. Date: Dec. 26, 2019

(54) Overhead Door Storage System

(71) Applicants: John C. Meyer, Gladstone, MO (US); Steven H. Harmon, Leawood, KS (US); Brandon A. Cusick, Kansas City, MO (US); Lisa Kauffman Kelly, Overland Park, KS (US)

(72) Inventors: John C. Meyer, Gladstone, MO (US); Steven H. Harmon, Leawood, KS (US); Brandon A. Cusick, Kansas City, MO (US); Lisa Kauffman Kelly, Overland Park, KS (US)

(21) Appl. No.: 16/017,628

(22) Filed: Jun. 25, 2018

(51) Int. Cl. A47B 95/00; E06B 7/28; A47B 81/00; A47B 63/00

(52) U.S. Cl. CPC A47B 95/00; A47B 63/00; A47B 81/005; E06B 7/28

(57) ABSTRACT

One embodiment of the overhead storage system uses the tube of a conventional overhead door hinge to releasably attach a rack with conventional ways to hold storage items. Another embodiment of an overhead door storage system uses the conventional hardware of a conventional overhead door to mount a rack with hooks to hold garage storage items on an overhead door. Another embodiment of the overhead storage system uses a bracket to mount a rack with hooks to hold garage storage items using the conventional hardware of a conventional overhead door. Other embodiments are described and shown.

### CROSS-REFERENCE TO RELATED APPLICATIONS

This application claims the benefit of provisional patent application Ser. No. 62604135, filed 2017 Jun. 23 by the present inventors.

### BACKGROUND—PRIOR ART

The Following is a tabulation of some prior art that presently appears relevant:

### U.S. Patents

| Pat. No. | Kind Code | Issue Date | Patentee |
|---|---|---|---|
| 7,240,823 | B1 | 2007 Jul. 10 | Saidiazar |
| 6,276,539 | B1 | 2000 Oct. 26 | Richbourg |

### U.S. Patent Application Publications

| Publication Number | Kind Code | Publication Date | Applicant |
|---|---|---|---|
| 20120234505 | A1 | 2012 Sep. 20 | Hartwig |
| 20110067310 | A1 | 2011 Mar. 24 | Murray |
| 20060038468 | A1 | 2006 Feb. 23 | Morgan |

### Nonpatent Literature Documents

Cobra garage door storage solutions pictures feature a garage door rack for tools and fishing rods on their website: cobrastorage.com.

The garages of homeowners and renters are notoriously cluttered as more and more items are not stored in the home due to inside storage space limitations, size, awkward shape of object, seasonality, or nature of being for outdoor use. Not only do the neighbors occasionally see this unsightly clutter, but also it can be a nuisance and danger to those walking around it. There is a need for an attractive storage system where items, and even the storage means one transports one's items in, can be stored and retrieved safely, quickly, and easily and that uses a previously unused storage area.

U.S. Pat. No. 7,240,823 and publication 20060038468 indicate a way that storage boxes can be attached to an overhead door panel. In both cases the storage boxes are bolted or screwed to the garage door panel, which causes it to be slow to install and remove. It will also damage and leave holes in the overhead door panel after removal.

U.S. Pat. No. 6,276,539 indicates a way to store fishing rods on a rack attached to an overhead door panel. These racks, I like the previous prior art example, are also bolted or screwed to the overhead door panel, and are also slow to install and remove, and will also damage and leave holes in the overhead door panel after removal.

The Cobra storage system rack can be bolted or screwed directly to the overhead door panel, and in some cases, the door panel trim can be bent back from the frame holding the panel and attached at that point. The Cobra storage system, is slow to install and remove. If the Cobra storage system is not screwed or bolted into the panel, it can be removed without damage to the garage door panel other than a possible slight bending of the door panel trim. The Cobra rack's closed loop design requires that the most of the fishing rods and long garden tools, or which it was designed, be threaded in from the side. This is difficult and can be impossible in some single car garages.

Publication 20110067310 uses the screw, or nut and bolt hardware that attaches the overhead door hinge to the overhead door in order to attach a flat netting to an overhead door panel. This netting is not designed to be easily removable. It will be slow to install and uninstall the netting. It may be difficult to fit the netting correctly without it being custom made. The reason it may need to be custom made is that it is up to each garage door installer to decide how many sets and how far apart horizontally the overhead door hinges are installed on an overhead door so there is no set length between the hinges to which the netting attaches itself.

Publication 20120234505 uses the outside of the overhead door hinge's pivoting horizontal cylinder to loop flexible strapping between two vertical hinges. This strapping also contains loops of strap for one to slide in fishing rods. The attachment method, though a little faster than the other options, still will take some time to thread and then loop each end through the hinges, and then hold the strap in place while tightening the strap through the fastener. The strapping lacks the sturdiness and clean appearance of more rigid racks. In addition, the strapping is very difficult to thread a fishing rod through. Also, threading in form the side, in some single car garages, is impossible.

We have found each prior art example mentioned above has weak or non-existent features that could benefit an overhead door storage system that include but are not limited to:
a. Prior art examples manner of attaching their device to the garage door makes it difficult to attach easily or quickly. For the same reason it makes it difficult to detach their device easily or quickly.
b. Prior art examples use loops to hold storage items. It is difficult, cumbersome and time consuming to thread storage items through hoops because it requires coming in from the side. Coming in from the side for some tools, sports equipment, and fishing rods, in some small garages, is not possible due to the space limitations.
c. Prior art of sturdy storage systems all require tools for installation and damage the overhead door panel.
d. Prior art examples require multiple steps and considerable time to produce each unit so it increases the cost of their manufacturing and their consumer sale price.

### SUMMARY

In accordance with one embodiment is a system of storing objects on an overhead door by connecting to at least to one hinge of an overhead door to a storage device that can transport or hold storage items, that can be quickly and easily be attached with no tools and the storage item the device stores can quickly and easily be loaded and unloaded.

### Advantages

According several advantages of one or more aspects of the overhead door storage system are as follows: to provide an easy to manufacture device for attaching storage items for storage to an overhead door, without damaging the overhead door, in a way that is easy and quick to install and remove, takes advantage of unused storage space, and to have a device that is easy and quick to store or to retrieve storage items.

### DRAWINGS—FIGURES

In the drawings, closely related items have the same last two digits in the number.

FIG. 1 shows one embodiment of a rack that can be attached to at least one overhead door hinge in accordance with one embodiment.

FIG. 2 shows a conventional overhead door hinge.

FIG. 3 shows the rack of FIG. 1 positioned just below an overhead door hinge ready to be installed.

FIG. 4 shows the rack of FIG. 1 attached directly to overhead door hinges in accordance with one embodiment of FIG. 1 and a second rack for storing long handled tools and rods shown next to it.

FIG. 5 shows one embodiment of a plastic rail.

FIG. 6 shows a mounting arm as a mean for connection for the rail of FIG. 5

FIG. 7 shows an attachment pin and an attachment clip, that works with the attachment pin, to attach the mounting arm to the plastic rail of FIG. 5 and is also used to attach the plastic rack of FIG. 9 to an overhead door hinge.

FIG. 8 shows parts from FIGS. 5, 6, and 7 staged and lined up for assembly.

FIG. 9 shows the items of FIG. 8 assembled.

FIG. 10 shows the assembled items of FIG. 9 positioned to be attached at the bottom to an overhead door hinge.

FIG. 11 shows the assembled items of FIG. 10 mounted on an overhead door hinges and also shows a second rack of FIG. 9 for storing long handled tools and rods.

FIG. 12 shows one embodiment of a single overhead door storage hook.

FIG. 13 shows the single overhead door storage hook of FIG. 12 mounted on a conventional overhead door hinge.

FIG. 14 shows one embodiment of a mounting bracket.

FIG. 15 shows the mounting bracket of FIG. 14 with a rack of FIG. 1 attached.

### DRAWINGS—REFERENCE NUMBERALS

| | |
|---|---|
| 102 plastic rail | 104 storage hooks |
| 106 mounting hook | 108 mounting hook support |
| | bracket |
| 110 cavity | 112 attachment loop |
| 114 support bar | 202 overhead door hinge tube |
| 204 overhead door hinge base | 206 overhead door hinge tube's |
| | hollow core |
| 402 attachment Means | 502 plastic rail |
| 504 hooks for storage items | 506 mounting hook |
| 508 “D” shaped mounting arm opening | 609 left mounting arm |
| 610 main arm | 612 mounting arm raised insert |
| 614 raised insert attachment hole | 616 arm mounting hole |
| 618 raised insert alignment rail | 720 attachment pin main shaft |
| 722 attachment pin clip | 804 storage item hook |
| 806 mounting hook | 808 alignment hook |
| 902 bracket base | 902 bracket tube |
| 904 bracket support | 906 bracket mounting hole |

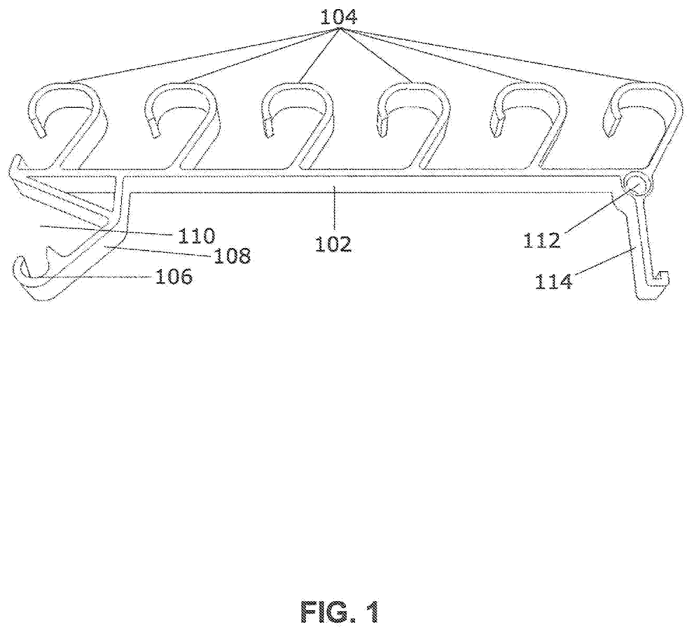

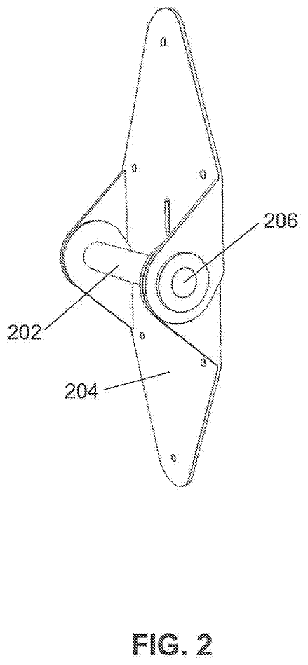

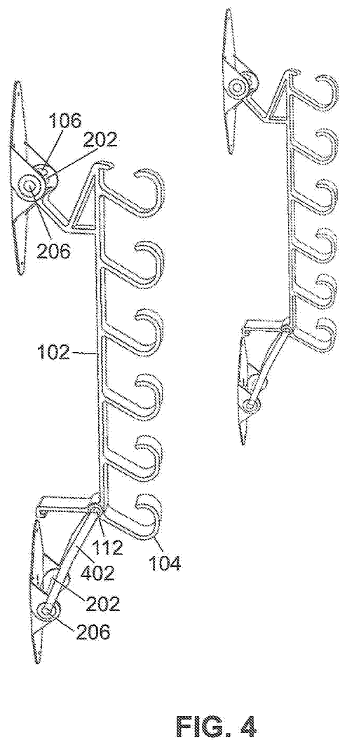

### DETAILED DESCRIPTION—FIG. 1, FIG. 2, AND FIG. 4—FIRST EMBODIMENT

One embodiment of the overhead door storage system is illustrated in FIG. 1. A plastic rack of FIG. 1 has multiple storage hooks 104 along a plastic rail 102 on it as a means for holding storage items in the vertical and horizontal position when mounted on a conventional overhead door (not shown). The storage hook 104 opening is of a size for conventional fishing rod handles, sporting goods handles, and garden tool handles (not shown).

The storage hook 104 is curled enough that rods cannot fall out due to gravitational pull when the overhead door is up and the plastic rail 102 is in a horizontal position with the storage hooks 104 of FIG. 1 hanging down. In this embodiment, at the top end and on the opposite side of the plastic rail 102 as the side of the storage hook 104, is a means for attaching the plastic rail 102 to an overhead door hinge tube 202 shown as a mounting hook 106. The opening to the mounting book 106 of FIG. 1 is of a size that the mounting hook 106 can be hooked over an overhead door hinge tube 202 of a conventional overhead door hinge of FIG. 2. The opening to the mounting hook 106 of FIG. 1 is angled to allow it to be hooked over an overhead door hinge tube 202 and when the plastic rail 102 is less than horizontal the plastic rack of FIG. 1 cannot fall off due to the mounting hook 106 stopping the gravitational downward pull. Additionally the design of the mounting hook 106 of FIG. 1 is such that, once it is hooked, it is allowed to swing freely around the overhead door hinge tube 202 of FIG. 2 but cannot slide off due to the lack of space between the overhead door hinge tube 202 and the overhead door hinge base 204 of FIG. 2.

The mounting hook 106 of FIG. 1 is attached to the plastic rail 102 by the means of a mounting hook support bracket 108 in such a manner that it creates a cavity 110 that allows the plastic rack of FIG. 1 to move with the conventional overhead door without interference from a higher overhead door panel or a conventional overhead door hinge when the overhead door is raised or lowered.

In this embodiment of FIG. 1 at the lower end of the plastic rail 102 a means for attaching the plastic rail 102 to a conventional overhead door as shown in FIG. 1 is an attachment loop 112 as a means for threading conventional attachment items that includes cable ties, cable, rope, string, cord, belt, tape, or other attachment means (many not shown) 402 of FIG. 4 to secure the lower end of the plastic rail 102 to the conventional overhead door.

Also in this embodiment of FIG. 1 at the lower end of the plastic rail 102 and on the opposite side from the storage hooks 104 is a support bar 114 of such a length to can keep the plastic rail 102 vertical when the overhead door is down. This support bar 114 of FIG. 1 also keeps the plastic rail 102 parallel to the overhead door panel when the conventional cable tie other attachment means 402 of FIG. 4 is treaded through attachment loop 112 and attached to the conventional overhead door panel. In this embodiment of the plastic rail 102, the support bar 114 of FIG. 1 is of a length longer than the width of a conventional hurricane strut (not shown) used on overhead doors for stabilization against hurricanes and strong winds. The distance of the furthermost edge of the mounting hook 106 of FIG. 1 to the plastic rail 102 should also be of the same length of the support bar 114 to keep the plastic rail horizontal to the overhead door panel, and not interfere with any conventional hurricane strut, when a conventional cable tie or other attachment means 402 of FIG. 4 is treaded through attachment loop 112 and attached to the overhead door panel.

### Operation—FIGS. 1, 2, 3, and 4

The manner of using the overhead door storage system in one embodiment of FIG. 1 is to attach one plastic rack of FIG. 1 each to two overhead door hinges that are horizontal to each other on a conventional overhead door panel as a means to create hooks that can hold fishing rods, garden tools, and other items.

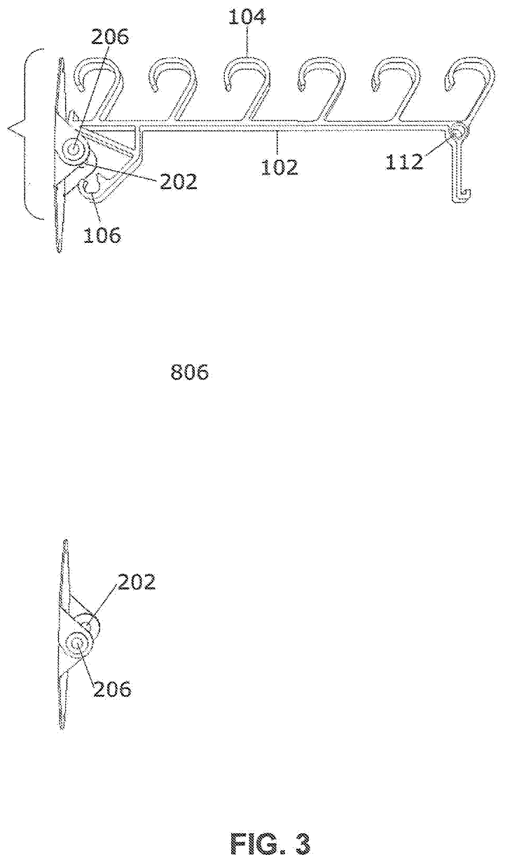

A plastic rack of FIG. 1 is attached to the overhead door hinge of FIG. 2 by positioning the plastic rail 102 at approximately a 90 degree horizontal angle to the overhead door and aligning the mounting hook 106 directly under an overhead door hinge tube 202 of FIG. 2 as shown in FIG. 3 and then moving the plastic rail 102 upwards till it is hooked on the overhead door hinge tube 202. Next reduce the angle of the plastic rail 102 to vertical as shown in FIG. 4 and the plastic rack of FIG. 1 will be secured by mounting hook 106 to an upper overhead door hinge tube 202. One then has the option of letting the plastic rack of FIG. 1 swing free as the overhead door goes up and down, or using a means for attaching the lower end of the plastic rail 102 to a lower overhead door hinge by using a means for attaching by utilizing a conventional attachment item including a strap, wire, cable, cable tie, or other attachment means (many not shown) 402 of FIG. 4 through the attachment loop 112 and then, in one embodiment, around the tube of a lower overhead door hinge 202 of FIG. 2 (not shown) OR, then through the hollow tube of the lower overhead door hinge 206 of FIG. 2 or as shown in FIG. 4. If the lower end of the plastic rail 102 is attached to a lower overhead door hinge it does creates more clearance for the plastic rack of FIG. 1 over vehicles parked under the overhead door when the overhead door is in the up position.

With two plastic racks now installed on an overhead door it is easy to load conventional long storage items (not shown) like fishing rods, sporting goods, garden tools and other long items directly onto the plastic rack of FIG. 1 using the storage hooks 104. This is done by loading the item in from the front and not by threading the handles of the conventional long storage items in from the side. These tools, sporting goods, rods and other long items then ride up and down with the overhead door without falling when the overhead door is raised.

### FIG. 1—ALTERNATIVE EMBODIMENTS

In other embodiments of the plastic rack of FIG. 1, the rack could be made of any combination of conventional sturdy materials including plastic, metal, wood, rubber, vinyl, polyurethane or other sturdy materials.

In other embodiments of the plastic rack of FIG. 1, the rack could be designed with a small draft so that it can quickly and inexpensively be produced by a single simple two-part straight pull injection mold.

In other embodiments of the plastic rack of FIG. 1, there could be a single storage hook 104 that is elongated and large enough to store conventional larger storage items including snow skis, water skis, ladders, paddleboards, and other large items (not shown).

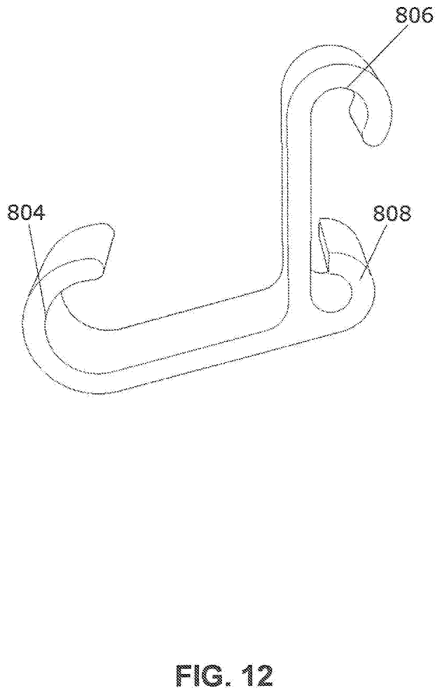

In other embodiments of the plastic rack of FIG. 1, the rack could have one hook as shown in FIG. 12, or multiple storage hooks 104 of FIG. 1.

In other embodiments of the plastic rack of FIG. 1, the rack, could have a means of attaching storage items including conventional means of attaching storage items including rings, straps, clamps, pins, carabineers, hook and loop fasteners, belts, clips, chests, drawers, bags, boxes, or cases (not shown).

In other embodiments of the plastic rack of FIG. 1, the rack could be attached to the overhead door by utilizing the overhead door hinge tube's hollow core 206 of FIG. 2 and connecting it to the plastic rack of FIG. 1 by using a conventional means of attachment including hooks, rings, straps, clamps, pins, carabineers, hook and loop fasteners, belts, cables, rope, cables, cable ties, or clips (many not shown).

In other embodiments of the plastic rack of FIG. 1, the rack could be attached to the overhead door by utilizing the overhead door hinge tube 202 of FIG. 2 and connecting it to the plastic rack of FIG. 1 by using a means clipping attachment that is selected from a group of conventional clipping attachments that includes clamps, carabineers, pins, hook and loop fasteners, reusable cable ties, or clips (not shown).

In other embodiments of the rack of FIG. 1 could have an attachment means that is releasably attached to the overhead door hinge. Thus the rack would be portable, quick, and easy to remove from a conventional overhead door to transport the storage rack of FIG. 1 and it's storage items in a vehicle. All then can be easily attached later at the same location or at a different location.

### DETAILED DESCRIPTION—FIG. 2, 5, 6, 7, AND 9—SECOND EMBODIMENT

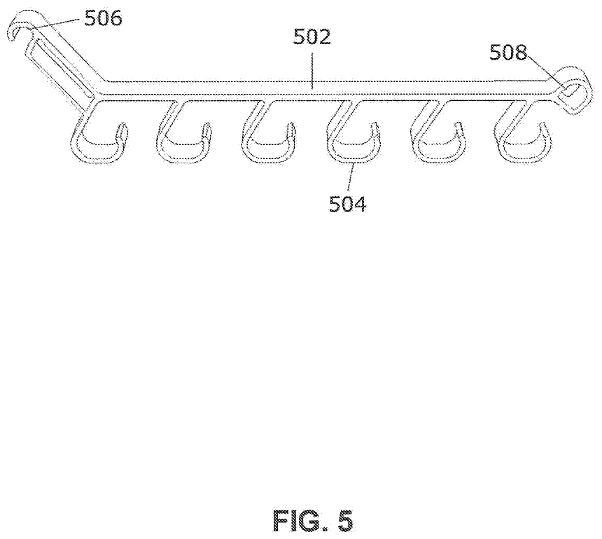

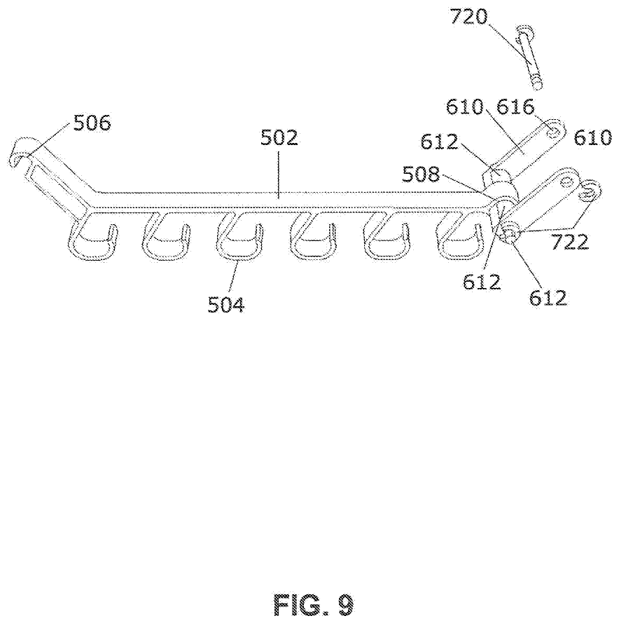

One embodiment of the overhead door storage system is illustrated in FIG. 9. A rack of FIG. 5 has multiple storage hooks 504 along a plastic rail 502 on it for holding storage items in the vertical and horizontal position when mounted on a conventional overhead door (not shown). The storage hook 504 opening is of a size for hanging conventional fishing rod handles, sporting goods handles, and garden tool handles (not shown).

The storage hook 504 is curled enough that the rods and handles cannot tall out due to gravitational pull when the overhead door is up and the plastic rail 502 would be in a horizontal position such that the storage hooks 504 of FIG. 5 would be hanging down. In this embodiment at the bottom end and on the opposite side of the plastic rail 502 as the hooks for holding storage items 504 is a means for attachment shown as mounting hook 506. The opening to the mounting hook 506 of FIG. 5 is of a size and at an angle that the mounting hook 506 can be hooked over a conventional overhead door hinge tube 202 of FIG. 2 when the plastic rail 502 is at an angle almost equal to horizontal to an overhead door hinge 202. When the plastic rail 502 is hooked and raised it can be secured in the vertical position.

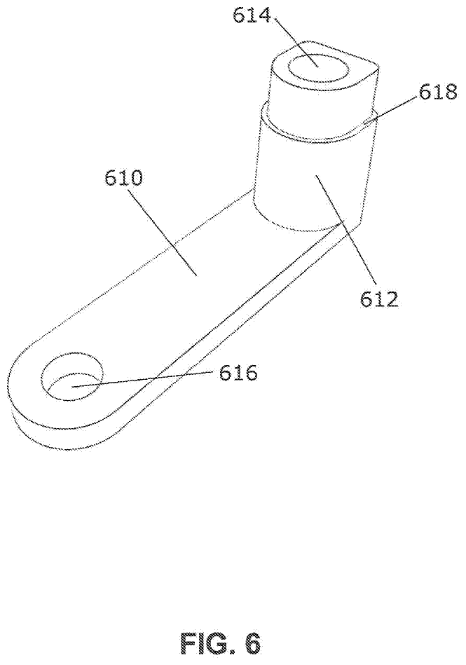

In this embodiment of the rack of FIG. 5 there is a means for connection of the plastic rail 502 to the conventional hardware of an overhead door utilizing two arms of FIG. 6. At the top end of the plastic rail 502 is an arm mounting opening 508 in the shape of a “D” for mounting a pair of the mounting arm of FIG. 6. At one end of the main arm 610 is a raised insert 612 in the shape of a “D” that fits into the mounting opening 508 at the end of plastic rail 502 of FIG. 5 in only one way. Through the middle of mounting arm raised insert 612 of FIG. 6 is a raised insert attachment hole 614. At the other end of the main arm 610 of the mounting arm of FIG. 6 is an arm mounting hole 616. The mounting arm raised insert 612 has a raised insert alignment rail 618.

The raised insert alignment rail 618 is positioned in a way so that when the arm raised inserts 612 are securely attached into the arm mounting opening 508 of FIG. 5 the main arms 610 of FIG. 6 are positioned far enough apart so that the distance between the main arms 610, when mounted, is greater than the width of a conventional overhead door hinge like FIG. 2.

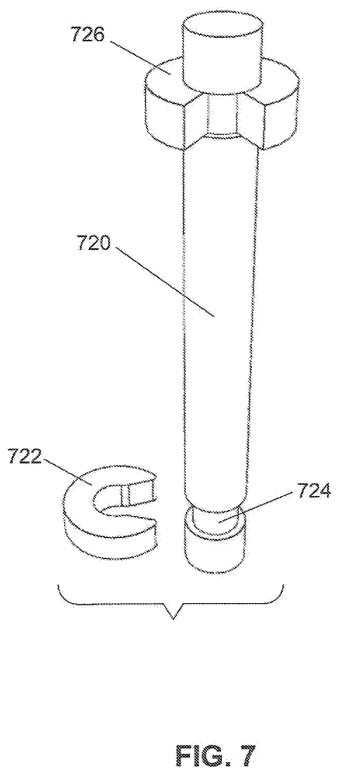

The raised insert attachment hole 614 and the arm mounting hole 616 of FIG. 6 are both of about the same diameter as a conventional overhead door hinge tube's hollow core 206 like that of FIG. 2. The mounting arms of FIG. 6 are secured to the plastic rail 502 of FIG. 5 by means of attaching utilizing an attachment pin main shaft 720 and an attachment pin clip 722 shown in FIG. 7. The attachment pin main shaft 720 is of a length long enough to secure the mounting arms of FIG. 6 to the plastic rail 502 of FIG. 5. The attachment pin main shaft 720 of FIG. 7 has a diameter smaller than the inside diameter of a conventional overhead door hinge tube's hollow core 206 like that of FIG. 2. The attachment pin clip 722 of FIG. 7 is of a size that it clips securely to the attachment pin of FIG. 7. With the mounting arms of FIG. 6 attached to the plastic rail 502 of FIG. 5, and the means of connection utilizing the mounting arms 610 and attaching them to the conventional hardware of an overhead door, the clearance between the plastic rail 502 and an overhead door panel should be at least the width of a conventional hurricane strut (not shown).

### Operation—FIGS. 2, 5, 6, 7, 8, 9, 10, and 11

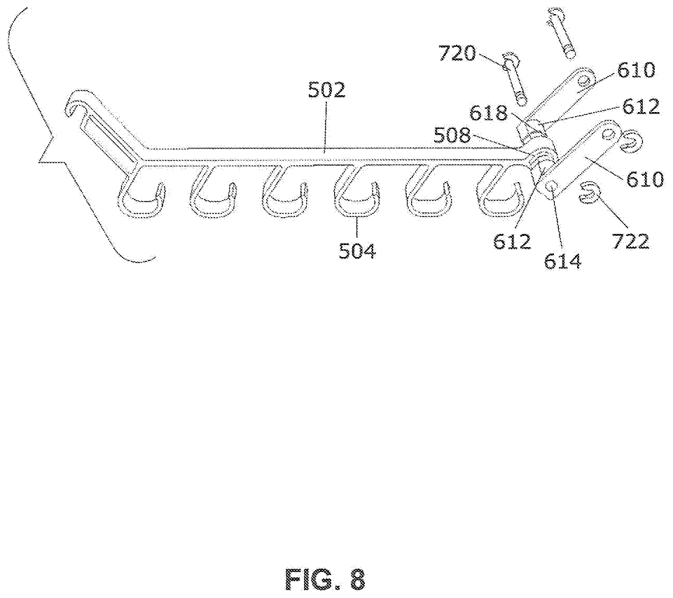

The manner of using the overhead door storage system in one embodiment shown in FIG. 8 is to attach two mounting arms of FIG. 6, one into each side of the arm mounting opening 508 at the end of the plastic rail 502 of FIG. 5, using the attachment pin main shaft 720 and the attachment pin clip 722 of FIG. 7 as shown in FIGS. 8 and 9.

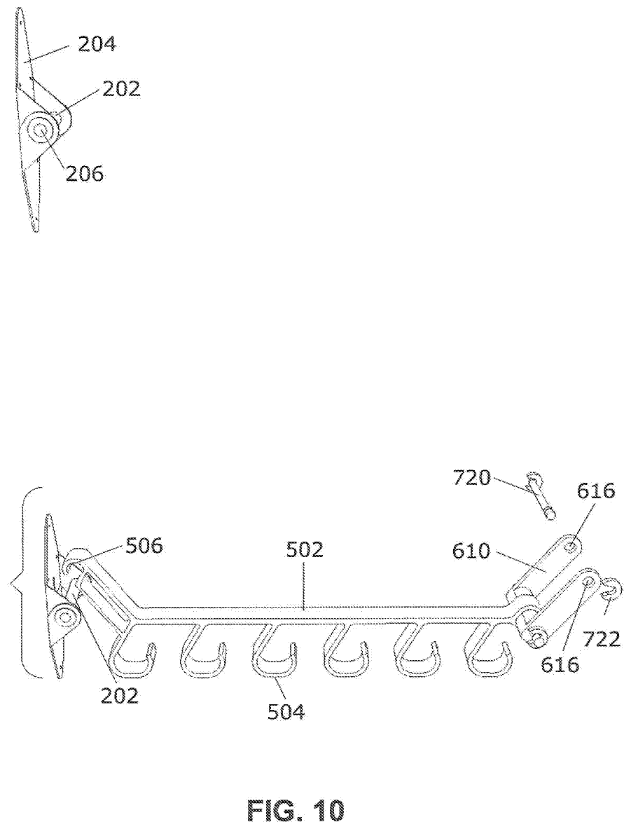

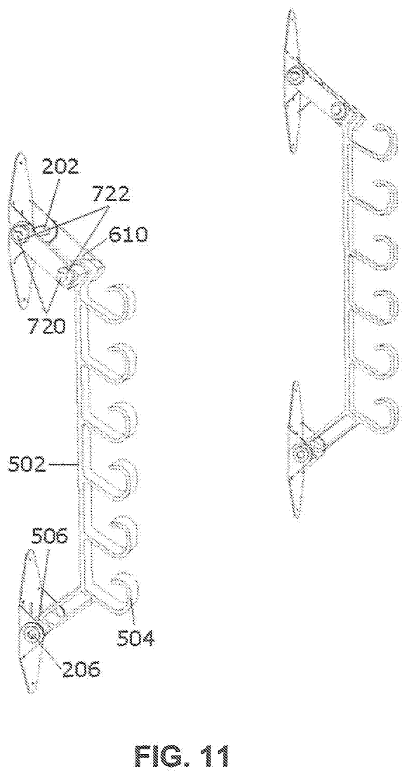

In one embodiment attach two plastic racks of FIG. 9, one each, to two conventional overhead door hinges of FIG. 2 that are horizontal to each other on a conventional overhead hinge of FIG. 2 by positioning the plastic rail 502 at approximately a 90 degree horizontal angle to the conventional overhead door and aligning the mounting hook 506 directly over the lower overhead door hinge tube 202 as shown in FIG. 10 an a conventional overhead door and then moving the plastic rail 502 straight down until mounting hook 506 is hooked on the conventional overhead door hinge tube 202. Next increase the angle of the plastic rail 502 to vertical, align the arm mounting holes 616 with the upper overhead door hinge tube's hollow core 206, insert an attachment pin main shaft 720 through the arm mounting holes 616 and the upper conventional overhead door hinge tube's hollow core 206 and secure with an attachment pin clip 722 as shown in FIG. 11.

In one embodiment two plastic racks of FIG. 9 installed on two overhead door hinges 202 as seen in FIG. 11 of a conventional overhead door it is easy to load conventional long storage items like fishing rods, garden tools and other long storage items (all not shown) directly onto the plastic racks of FIG. 8 using the storage hooks 504 without threading in from the side. These tools, sporting goods, and rods then ride up and down with a conventional overhead door (not shown) without falling when the conventional overhead door is raised.

### ALTERNATIVE EMBODIMENTS

In other embodiments of the plastic rack of FIG. 9, the rack could be made of any combination of conventional sturdy materials including plastic, metal, wood, rubber, vinyl, polyurethane or other conventional sturdy materials.

In other embodiments the rack of FIG. 9 could be attached to the conventional hardware of an overhead door that includes nuts, bolts, screws, hinges, and overhead door panel trim (not shown) by using a means of connection utilizing a means of attaching a means of connection to conventional hardware of an overhead door with a conventional means of attachment item including hooks, rings, straps, clamps, pins, loops carabineers, hook and loop fasteners, belts, cables, rope, cables, cable ties, screws, nuts or clips (not shown).

In other embodiments of the plastic rail 502 of FIG. 5, instead of multiple storage hooks 504, there could be a single storage hook 504. The storage hook 504 can be of a size to hold conventional storage items including bags, handles, belts, rods, and garden tools (not shown).

In other embodiments the storage hook 504 of FIG. 5 could be elongated and large enough to store larger conventional storage items including snow skis, water skis, ladders, paddleboards, and other larger conventional storage items (not shown).

In other embodiments the rack of FIG. 9 could be designed with a draft so that it can be quickly and inexpensively produced by simple two-part straight pull injection molds.

In other embodiments of the plastic rack of FIG. 5, the plastic rail 502 instead of storage hooks 504 it could have conventional means for storing items including hooks, clamps, pins, carabineers, clips, a chest, a box, a bag, or a case (not shown) or any combination thereof.

In other embodiments the rack of FIG. 9 could be releasably attached to the conventional hardware of a conventional overhead door. This would make the rack portable and quick and easy remove from an overhead door. This would also make it easy to reattach.

In other embodiments of the rack of FIG. 9 could have an attachment means that is releasably attached to the overhead door hinge.

### DETAILED DESCRIPTION—FIG. 12—THIRD EMBODIMENT

One embodiment of the overhead door storage system is illustrated in FIG. 12. An overhead door storage mounting hook shown in FIG. 12 is designed to hook on a conventional overhead door hinge tube 202 of FIG. 2 and swing freely as an overhead door is raised and lowered without hindrance from any part of the rest of the conventional overhead door hinge or it's conventional hardware. In this embodiment the storage hook 804 is designed with enough curl to keep storage items from falling off when the overhead door goes up and down.

The opening to the mounting hook 806 of FIG. 12 is of a size that the mounting hook 806 can be hooked over a conventional overhead door hinge tube 202 of FIG. 2. This embodiment also includes an alignment hook 8418 as seen in FIG. 12. The alignment hook 808 is of a size to align the storage hook 804 away from the base of the conventional overhead door hinge 204 of FIG. 2 to better store the storage items.

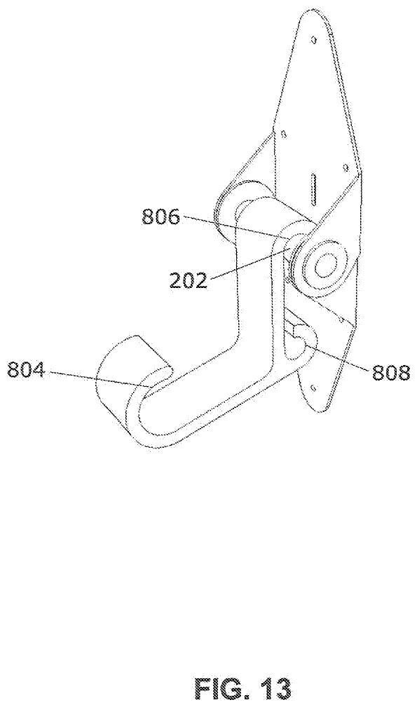

### Operation—FIGS. 12, and 13

The manner of using the overhead door storage system in one embodiment of FIG. 12 is to attach the mounting hook 806 of FIG. 12 to a conventional overhead door hinge tube 202 of FIG. 2 as shown in FIG. 13.

Storage hook 804 of FIG. 12 is designed to hold conventional means for hanging conventional items to be stored including bag straps, cables, rope, handles, rings, clips, belts, cords, caps, bags, rods, poles, wire, and paint cans (not shown) in such a way that storage items do not fall off when a conventional overhead door is raised or lowered.

Alignment hook 808 and mounting hook 806 of FIG. 12 can also be a means for attaching conventional means for hanging conventional items to be stored including cables, rope, handles, rings, clips, belts, cords, wire, and other garage storage items (not shown).

### ALTERNATIVE EMBODIMENTS

In other embodiments of the overhead door storage hook of FIG. 12 the storage hook could be made of any combination of conventional sturdy materials including plastic, metal, wood, rubber, vinyl, polyurethane or other conventional sturdy materials.

In other embodiments of the overhead door storage hook of FIG. 12 the storage hook could be made to fit larger conventional storage items including paddleboards, golf bags, snow skis, water skis, and other larger conventional storage items (not shown).

In other embodiments the part of FIG. 12 the storage hook could be designed with draft and quickly and inexpensively produced by a two part straight pull injection mold.

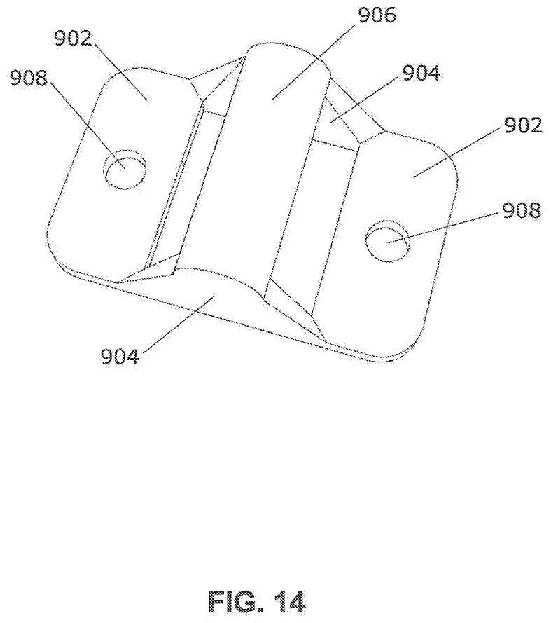

### DETAILED DESCRIPTION—FIG. 14—FOURTH EMBODIMENT

One embodiment of the overhead door storage system illustrated in FIG. 14 is a bracket as a means for attaching the plastic rack of FIG. 1 to the conventional hardware of a conventional overhead door that includes nuts, bolts, screws, hinge, and overhead door panel trim (all not shown) of a conventional overhead door (not shown). The bracket of FIG. 14 with a bracket base 902 has bracket supports 904 to hold a bracket tube 906 at approximately the same height as a conventional overhead door hinge tube 202 as in FIG. 2 with clearance under the bracket tube 906 to the bottom of the bracket base 902 of FIG. 14. The bracket tube 906 is approximately the same diameter as a conventional overhead door hinge tube 202 as in FIG. 2. The bracket base 902 of FIG. 14 has mounting holes for mounting to the conventional hardware of a conventional overhead door.

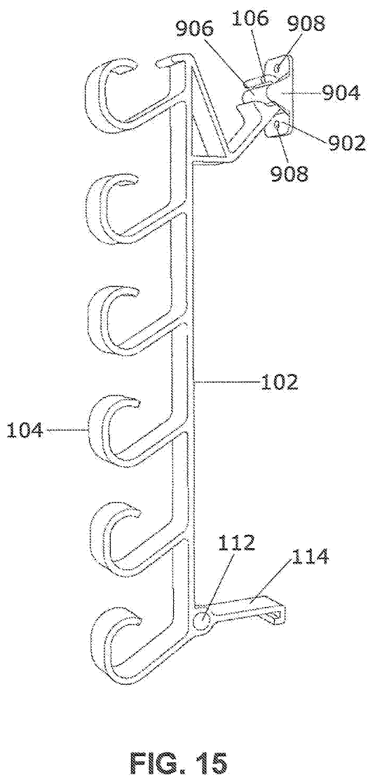

### Operation—FIGS. 14, and 15

The manner of using the overhead door storage system mounting bracket of FIG. 14, in one embodiment, is to attach the mounting bracket of FIG. 14 by using the mounting hole 908 of the mounting bracket of FIG. 14 to attach the mounting bracket of FIG. 14 to the conventional hardware of a conventional overhead door (not shown) using conventional hardware attaching items including screws, nuts or bolts (not shown) in a way that the plastic rack of FIG. 1 can be attached to the mounting bracket of FIG. 14 as shown in FIG. 15.

### ALTERNATIVE EMBODIMENTS

In other embodiments of the overhead door storage system the mounting bracket of FIG. 14 could be attached to a wall or a ceiling such that the plastic rack of FIG. 1 could be attached anywhere without the need of an overhead door.

In other embodiments the mounting bracket of FIG. 14 could be designed with draft and quickly and inexpensively produced by a simple two part straight pull injection mold.

### Advantages

From the description above, a number of advantages of some embodiments of our overhead door storage system become evident:
(a) There is an advantage of using the hollow center of an overhead door hinge tube to attach racks and attachment devices that can store storage items because it is already attached to the overhead door, and offers an opening to use attachment means to attach a device for storing an item that quick and easy to use,
(b) There is an advantage of using the hollow center of an overhead door hinge tube to attach racks and attachment devices that can store storage items without adding additional hardware to an overhead door. Usually adding additional hardware damages the overhead door and increases the weight load.
(c) There is an advantage in using a storage device that can store storage items with a means to hook on an overhead door hinge tube because it can simply, quickly and easily be installed and removed without tools.
(d) There is an advantage of using the hollow center of an overhead door hinge tube or hooking to the outside of the overhead door hinge tube to attach racks and attachment devices with the means to store storage items because the overhead door hinge tube is already there so it requires less additional hardware for attachment. Additional hardware can add weight, take time to install, be cumbersome, be less attractive, be less streamlined and not as well secured.
(e) There is an advantage in using a storage device that uses a more rigid hook, carabineer, or other more rigid removable attachment device as a means to attaching to an overhead door hinge tube because it can be more quickly and easily be installed and removed than a storage device that utilizes a flexible more permanently attached loop.
(f) There is a clear advantage in using hooks to a attach long storage item to an overhead door because of the ease of directly and quickly storing and removing rods and long handled storage items rather than having to thread them in through a loop from the side as is such in all the prior art overhead door storage devices. The surprising thing is considering using hooks on an overhead door because the overhead door, and hence the storage device, changes from vertical to horizontal.
(g) There is an advantage in having a product that can be made out of large choice of sturdy materials.
(h) There is an advantage in having a product that has a means to attaching to an overhead door's hardware in many ways without damaging the overhead door.
(i) There is an advantage of making future storage hooks made specifically for one type of item that requires storing.
(j) There is an advantage in designing an overhead door storage device that can be more inexpensively manufactured using just a simple straight pull injection mold.
(k) There is an advantage in using a hook as a means for storing storage items as it is so much more versatile, can accommodate a larger range of items, and is quick and easy to use.
(l) There is an advantage in having a mounting bracket that allows the overhead door storage device to be stored using the overhead door's hardware when the overhead door hinge's tube is not available or ideal for use.
(m) There is an advantage in having a mounting bracket that can be attached anywhere so the overhead storage device can store items, not just on an overhead door, but instead on walls and ceilings anywhere.
(n) There is an advantage in having releasably attachable connection devices, like arms, that have a means to attach the storage device and to the overhead door hinge to make it easier and quicker to attach and detach.
(o) There is an advantage in having the books of the storage device releasably attachable so that they can be removed with a storage item, be removed to allow more room for larger storage items on the device, or be removed so they can be replaced with a different kind of storage attachment means.
(p) There is an advantage in designing the storage device so that it aligns with the overhead door when it is in vertical position so as to make the items hang correctly and so when it is in it's horizontal position so that it has more clearance over items under it and insures the hooks stay at an angle that items that are stored on the device cannot fall out.

### CONCLUSIONS, RAMIFICATIONS, AND SCOPE

Accordingly, the reader will see that the overhead door storage system's various embodiments for storing garage storage items can be attached attractively, easily and quickly to the overhead door hardware and just as easily removed without damage to the overhead door or it's hardware. It is also easy and quick store and remove storage items

Furthermore, the garage storage system has the additional advantages in that
it permits the storage of items in a previously unused area, thereby freeing up space that can be used for something else.
it is lightweight and it can be installed in seconds without any tools to conveniently stores awkward and difficult items off the floor that can be a hindrance and danger to be around.
it displays items like fishing rods and kayak paddles to be enjoyed and viewed on each trip into the garage.
it creates a place to store items that can be transported inside a car or in the trunk of a car that is very close and handy to load and unload an replaced on the original overhead door or transported with the storage items to a another garage door.

Although the description above contains may specificities, these should not be construed as limiting the scope of the embodiments, but as merely providing illustration of some of the embodiments.

Thus the scope of the embodiments should be determined by the appended claims and their legal equivalents, rather than by the examples given.

1. A means of storing objects, comprising:
a. an overhead door with an overhead door hinge,
b. said overhead door hinge with a hollow tube,
c. a sturdy device for storing objects with at least one means for storing said object, and
d. said sturdy device for storing objects having a means for attaching said sturdy device for storing objects to said hollow tube of said overhead door hinge,
whereby, objects may be stored on said sturdy device for storing objects on said overhead door with said overhead door hinge by utilizing said means for attaching said sturdy device for storing objects to said hollow tube of said overhead door hinge thereby said sturdy device for storing objects is attached to said hollow tube of said overhead door hinge of said overhead door.

2. The means of storing objects of claim 1 wherein said device for storing objects is made from a sturdy material selected from a group of sturdy materials including plastic, metal, wood, rubber, vinyl, polyurethane or other sturdy materials.

3. The means of storing objects of claim 1 wherein said sturdy device for storing objects is designed to be drafted such that said sturdy device for storing objects is be made in a single directional pull injection mold.

4. The means of storing objects of claim 1 wherein said means for storing objects is selected from the group of said means for storing objects including hooks, rings, straps, clamps, pins, carabineers, hook and loop fasteners, belts, clips, chests, drawers, bags, boxes, or cases.

5. The means of storing objects of claim 1 wherein the means for attaching said sturdy device for storing objects to said hollow tube of said overhead door hinge utilizes said hollow of said hollow tube of said overhead door hinge by means for attaching to said hollow of said hollow tube of said overhead door hinge selected from a group of means for attaching to said hollow of said hollow tube of said overhead door hinge including hooks, rings, straps, clamps, pins, carabineers, hook and loop fasteners, belts, cables, rope, cables, cable ties, clips or other means for attaching to said hollow of said hollow tube of said overhead door hinge.

6. The means of storing objects of claim 1 wherein said sturdy device for storing objects to said hollow tube of said overhead door hinge utilizing said means for attaching is to clip the said sturdy device for storing objects of claim 1 to said hollow tube of said overhead door hinge providing a means for clipping is selected from a group of means for clipping consisting of hooks, clamps, pins, carabineers, cable ties, or clips.

7. The means of storing objects of claim 1 wherein said sturdy device for storing objects to said hollow tube of said overhead door hinge utilizing said means for attaching is to hook the said sturdy device for storing objects of claim 1 to said hollow tube of said overhead door hinge providing a means for hooking is selected from a group of means for hooking consisting of hooks, clamps, pins, carabineers, cable ties, or clips.

8. The means of storing objects of claim 1 wherein said means for attaching said sturdy device for storing objects to said hollow tube of said overhead door hinge utilizes said means of attaching that is a means for releasably attaching said sturdy device for storing objects to said hollow tube of said overhead door hinge.

9. The means of storing objects of claim 1 wherein said sturdy device for storing objects is attached by means for attaching to a device of connection that has a means for attaching said sturdy device for storing objects to said device of connection and a means for attaching said device of connection to said hollow tube of said overhead door hinge of said overhead door.

10. The means of storing objects of claim 1 wherein said sturdy device for storing objects with at least one means for storing said object said means for storing said object is releasably attached to said sturdy device for storing objects utilizing a means for releasably attaching said sturdy device for storing objects to said means for storing said object.

11. The means of storing objects of claim 1 wherein said sturdy device for storing objects is designed such that said sturdy device for storing objects aligns with said overhead door.

12. A means of storing objects, comprising:
a. an overhead door with overhead door hardware,
b. said overhead door having said overhead door hardware that includes nuts, bolts, screws, hinges, and overhead door panel trim,
c. a device for storing an object on at least one hook,
d. said device for storing said object on at least one hook having a means for attaching said device for storing to said hardware of said overhead door.
whereby, said object may be stored on said overhead door providing said object is stored on said hook of said device for storing and providing said device for storing is attached by said means of attaching to said device for storing said object on said hook to said overhead door hardware of said overhead door.

13. The means of storing objects of claim 12 wherein said device for storing said object on at least one hook of said device is designed with drafted sides such that said device for storing of claim 12 is made in a single directional pull injection mold.

14. The means of storing objects of claim 12 wherein said device for storing said object on at least one hook said hook could be a clamp, a carabineers, a clip, a chest, a drawer, a bag, a box, or a case.

15. The means of storing objects of claim 12 wherein the means for attaching said device for storing said object on at least one hook to said overhead door having said overhead door hardware is selected from the group of means for attaching including hooks, rings, straps, clamps, pins, loops carabineers, hook and loop fasteners, belts, cables, rope, cables, cable ties, screws, nuts or clips.

16. The means of storing objects of claim 12 wherein the means for attaching said device for storing said object on at least one hook has a means for attaching to a bracket that has a means for attaching said bracket to said hardware of said overhead door.

17. The means of storing objects of claim 12 wherein said device for storing said object on at least one hook utilizes a releasable means of attachment to attach said device for storing said object on at least one hook to said hardware of said overhead door.

18. The means of storing objects of claim 12 wherein said device for storing said object on at least one hook is designed such that said sturdy device for storing objects aligns with said overhead door when attached.
